(19) United States
(12) Patent Application Publication
(10) Pub. No.: US 2022/0048287 A1
(43) Pub. Date: Feb. 17, 2022

(54) INKJET PRINTING

(71) Applicant: Global Inkjet Systems Limited, Cambridge (GB)

(72) Inventors: Damian Howard Laurence Smith, Hardwick (GB); Nicholas Campbell Geddes, Lidgate (GB); Alberto Donado Rodriguez, Royston (GB)

(21) Appl. No.: 17/515,437

(22) Filed: Oct. 30, 2021

Related U.S. Application Data
(63) Continuation of application No. PCT/GB2019/051457, filed on May 29, 2019.

(51) Int. Cl. B41J 2/045

(52) U.S. Cl. CPC B41J 2/04596; B41J 2/04581; B41J 2/04541; B41J 2/04588

(57) ABSTRACT

A drive system for individually switched nozzles with common drive signals of an inkjet print head, including a nozzle controller associated with each nozzle whereby meniscus activation is determined by a meniscus activation pulse, MAP, signal to that nozzle. A MAP controller defines a parameter for each nozzle such that the parameter is monitored by the MAP controller whereby a MAP signal is provided to the nozzle controller as required dependent upon the parameter, each nozzle configured whereby once the MAP signal is provided to provide meniscus activation at the nozzle any further nozzle fire signals, in the form of the common drive signals after the MAP signal, are delayed at least until the meniscus activation at the nozzle is complete while the nozzle controller ensures all the nozzle fire signals as common drive signals remain in sequence with each other.

### CROSS-REFERENCE TO RELATED APPLICATION

This application is a continuation of and claims priority to PCT/GB2019/051457 filed May 29, 2019, the entire disclosure of which is incorporated by reference herein.

### TECHNICAL FIELD

This invention relates to inkjet printing and in particular relates to aspects of improvements in nozzle operation.

### BACKGROUND

Modern inkjet print heads commonly consist of an array of individually switched nozzles, each of which comprise a piezoelectric actuator/transducer that is arranged to force ink from the nozzle when activated. These piezoelectric actuators/transducers are driven by a drive circuit/system which provides a voltage waveform or common drive signal that is configured to result in the ejection of a droplet of ink from a nozzle, where each waveform is defined by amplitude and time. In most applications, a single power amplifier provided in the drive circuit/system supplies a common drive signal to many (typically hundreds) of nozzles, and a separate controller provides switching data/inputs to the print head that determines which of the individually switched nozzles are to be enabled for a given instance of the drive signal. Consequently, by arranging a coordinated sequence of drive signals and switching inputs, the print head produces an image on the target substrate.

As ink (or another fluid for jetting) remains static in or near a nozzle, its physical and chemical properties can change. For example, heat, light, absorption of atmospheric gasses, settling, separation, and evaporation can lead to changes in the rheology, and the meniscus might move relative to its ideal position in the nozzle. There is a desire for best print quality but if the ink is not ready and in the ideal condition, nozzles might not jet, or might jet differently. The common drive signal assumes readiness of the nozzle. If this is not the case, it can lead to a need for print head priming or cleaning to improve the performance of the nozzles.

There will inevitably in any practical printing situation be periods when the printing process has to be paused and/or slowed and/or gaps in printing. These can be when scan printing at the end of a print head pass or printing regions are widely spaced such as on a production line and/or just idle time between print jobs. Maintaining the print head at or nearer to a print ready state would have advantages.

It is known to use a controller and print strategy to drive one or more print heads at a time. This controller is part of a so-called head interface board (HIB) so that data is loaded on to the head and this provides appropriate signals to fire (project ink) the head nozzles at the right time and location. To maintain the head ready for firing of ink it is known to provide small non-jetting pulses (meniscus activation pulses—MAPs) at the start or end of an ink ejection even for non-jetting nozzles but this is useful only if the print head is being jetted. It is also known as a preventative measure to trigger these MAP processes at a fixed frequency between print jobs i.e. if the printer is being left in an idle state for a pre-determined time parameter to conserve power or otherwise before data is provided for the next job.

The present invention therefore seeks to provide an improved printer head in readiness for each nozzle/jet without too great an impingement upon effectiveness.

### SUMMARY

According to a first independent aspect of the present invention, a drive system is disclosed. In other words, a drive system for a plurality of individually switched nozzles with common drive signals of an inkjet print head, the system comprising:

a nozzle controller associated with each nozzle whereby meniscus activation is determined by a meniscus activation pulse, MAP, signal to that nozzle; and

a MAP controller defining a parameter for each nozzle and such that the parameter is monitored by the MAP controller whereby a MAP signal is provided to the nozzle controller as required dependent upon the parameter, each nozzle configured whereby once the MAP signal is provided to provide meniscus activation at the nozzle, any further nozzle fire signals, in the form of the common drive signals after the MAP signal, are delayed by a delay period for all nozzles at least until the meniscus activation at the nozzle is complete while the nozzle controller ensures all the nozzle fire signals as common drive signals remain in sequence with each other.

The nozzle controller is thus configured whereby fire waveforms are delayable by a configurable fire latency (delay period).

Advantageously therefore, the at least one nozzle may be configured such that the MAP signal may have time to complete without preventing, delaying, or altering the delayed fire waveforms, whereby the resultant print quality will not be negatively affected by the provided MAP signals.

Advantageously, the MAP signal may be part of a waveform signal to drive the nozzle whereby the ink in or near the nozzle is maintained in a better condition for printing.

In some aspects, the delay period is determined such that any time for power down and power up of the printhead is less than the delay period.

In a comparative example, there is provided a drive system for a plurality of individually switched nozzles with common drive signals of an inkjet print head, the system comprising:

a nozzle controller associated with at least one nozzle whereby meniscus activation is determined by a meniscus activation pulse, MAP, signal to the at least one nozzle, the nozzle controller being configured whereby fire waveforms are delayable by a configurable fire latency; and

a MAP controller defining at least one parameter for the at least one nozzle and such that the at least one parameter is monitored by the MAP controller, whereby a MAP signal is provided to the nozzle controller as required, the at least one nozzle configured such that the MAP signal has time to complete without preventing, delaying, or altering the delayed fire waveforms.

In some aspects, a method is disclosed of operating a plurality of individually switched nozzles of an inkjet print head with common drive signals, wherein the method comprises:
a) determining a meniscus activation pulse, MAP, signal for meniscus activation by a MAP signal for each nozzle of a print head; and
b) defining a parameter for at least one nozzle such that the parameter is monitored whereby the MAP signal is provided to a nozzle controller as required dependent upon the parameter, each nozzle configured whereby there is a fixed delay period at least until meniscus activation at the nozzles by the MAP signal is complete, the nozzle controller ensures that a subsequent nozzle fire signal as common drive signals are delayed by the fixed delay period but remain in sequence with each other.

Other example features of aspects of the present invention are disclosed herein.

### BRIEF DESCRIPTION OF THE DRAWINGS

Aspects of the present invention will now be further described, by way of example only, with reference to the accompanying figures; in which

FIG. 1 is a diagram illustrating standard prior idle meniscus signal sequence;

FIG. 2 is a diagram illustrating another standard meniscus signal as part of a normal jetting waveform;

FIG. 3 is a diagram illustrating meniscus activation signal sequencing in accordance with aspects of the present invention;

FIG. 4 is a diagram illustrating a potential error with a different meniscus signal sequencing implementation;

FIG. 5 provides a schematic illustration of a meniscus activation method in accordance with aspects of the present invention;

FIG. 6 is a flow diagram of a MAP process used in accordance with aspects of the present invention;

FIG. 7 is a flow diagram of a timer process used in accordance with aspects of the present invention;

FIG. 8 provides an illustration of fire trigger signals stages F, printer head waveforms and a power holdoff for a printhead in a first scenario;

FIG. 9 provides an illustration of fire trigger signals stages F, printer head waveforms and a power holdoff for a printhead in a second scenario; and

FIG. 10 provides a schematic illustration of multiple fire trigger signals being queued in accordance with further aspects of the present invention.

### DETAILED DESCRIPTION

As described above, each of a plurality of individually switched nozzles in a print head typically comprises a piezoelectric actuator/transducer and a common drive signal would therefore be configured to activate the piezoelectric actuator/transducer in order to eject ink from the nozzle towards a recording medium.

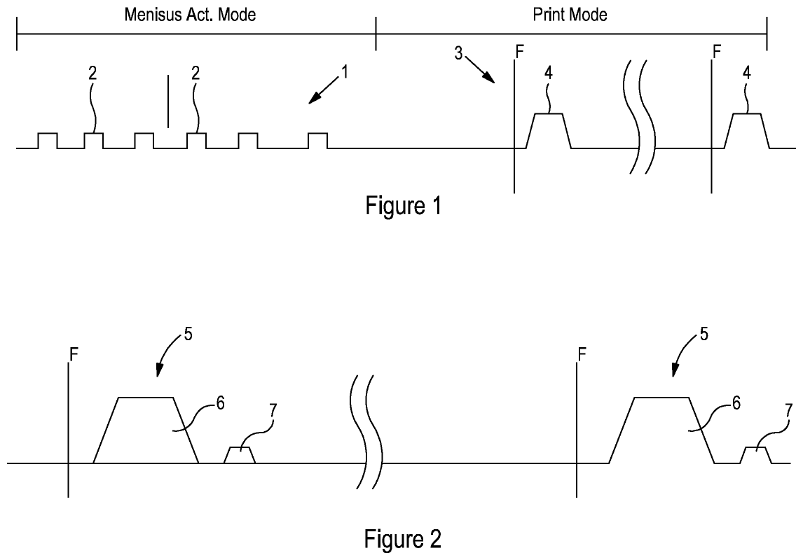

FIG. 1 is a diagram illustrating an example of a standard prior signal pulse sequence for meniscus activation over time. In first time period 1 a print head is in a meniscus activation mode with a number of meniscus activation pulses 2 provided at spaced and regular intervals while the print head itself is idle. In a print mode depicted in time period 3 the print head receives a number of fire signals 4 to perform the printing process. In this standard signal sequence depicted in FIG. 1 it will be understood that the meniscus activation pulses 2 are only provided during idle periods so there are no conflicts with fire signals 4 for printing. A problem is that the fire signals 4 for each operation of the print head can be provided at any time so in reality there may be overlap and conflict between a meniscus activation signal 2 and a common fire or drive signal 4 unless idle periods are entirely predictable, which they are not.

One approach as outlined in FIG. 2 is to provide for each fire sequence 5 comprising a common nozzle activation or fire signal 6 to drive image nozzles that are always followed by a meniscus activation signal 7 immediately thereafter for all nozzles. The image nozzles activated are those needed to form an image so after firing will not really need meniscus activation. A general meniscus activation signal 7 to all nozzles this will ensure that all nozzles are primed, that is to say have received meniscus activation ready for a print function if and when needed so all are ready not just those recently activated.

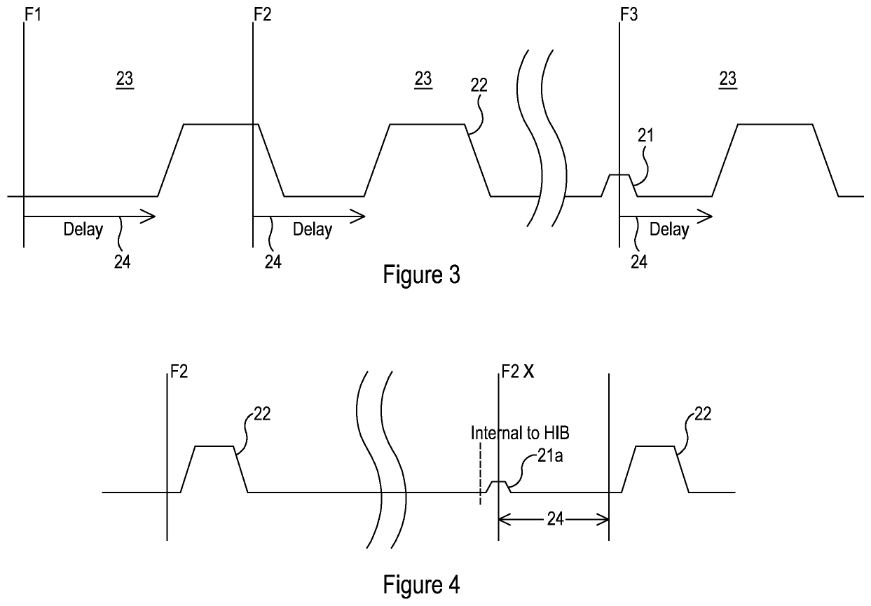

FIG. 3 provides an illustration of a signal sequence of pulses in accordance with aspects of the present invention to provide ‘smart’ meniscus activation signals 21 interspersed with fire signals 22 for nozzles in a print head (not shown). The fire signals are arranged in fire periods 23 denoted by the references F1, F2 and F3 along a time line. Each fire signal 22 to drive the nozzles is delayed or has a fixed latency 24 which means that, as illustrated with regard to F3, if a meniscus activation signal 21a coincides with a notional fire signal due in F3, that signal in F3 is delayed by a fixed amount so that the MAP signal 21a can be completed prior to the effect of the fire or common drive signal 22 to all the nozzles of the print head.

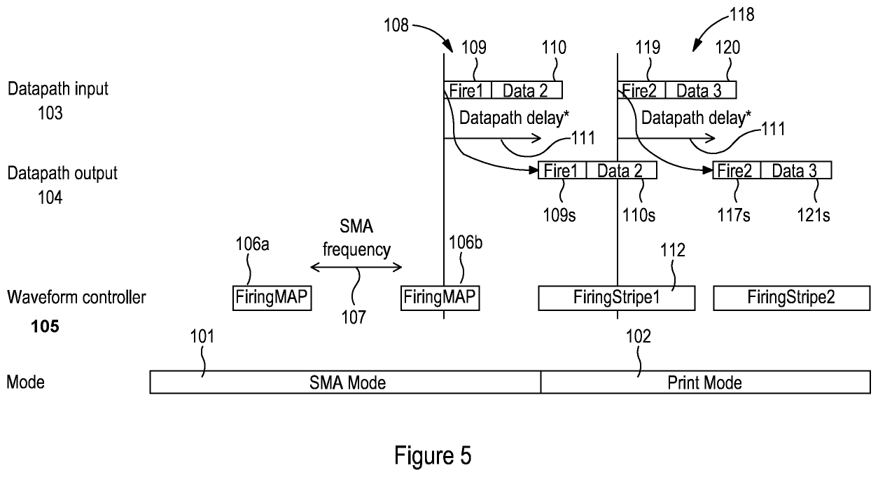

FIG. 4 further illustrates the fire signals 22 and the meniscus activation signal 21a as previously depicted in FIG. 3. As can be seen in FIG. 4, the meniscus activation signal 21a coincides with a second common drive signal F2. The meniscus activation signal 21a is normally initiated by the controller (HIB) internally so has no coordination with the fire signals 22 as common drive signals to the nozzle. This conflict between the meniscus activation signal 21a generated by the HIB with the common drive signal would present problems if in accordance with aspects of the present invention there is no fixed latency in application of the fire signal 22 by the delay 24. The fixed delay 24 is set for a print head such that all meniscus activation signals 21 processes are completed prior to the application of the signal 22 as a common drive signal to the nozzles of the print head.

With drive signals for printing steps there may be significant overlap. Some degree of overlap within each of the printing steps improves the overall speed and efficiency by allowing the print data to stream through the system and with each component of the system possibly working on different parts or sections of a print job or even different print jobs simultaneously. By way of example, for each ink ejection the control signals that are used to switch on/enable the required nozzles are typically transmitted to the print head before the common drive signal is sent to the print head. For efficiency, the sending of the control signals for the next in the sequence of ink ejections is then overlapped with the sending to the print head of the common drive signal for the preceding ink ejection. The overlap may also allow provision of meniscus activation pulse (MAP) signals in accordance with aspects of the present invention without overly interrupting normal operation of the printer.

In a multiple nozzle and jet system each nozzle and jet will only be operative for certain periods of time and dormant (idle) at others. Nevertheless, by consideration of near future loads on these nozzles some of the deleterious effects can be mitigated by design choice. Such design choice depends upon a prediction of nozzle performance and readiness. Aspects of the present invention attempt to provide greater certainty or at least improve the accuracy of prediction of nozzle performance and especially readiness so the drive strategies are then more effective with an improvement of print quality.

The nature of a nozzle or jet is that it ejects ink. The readiness of each nozzle can be broadly dependent upon the state of ink at the outlet of the nozzle or jet—a too withdrawn retracted ink meniscus at the outlet will affect print quality due to the less than predicted initial ink position in the nozzle or jet as it is driven. By use of a small pulse (meniscus activation pulse—MAP) at the start or end of a nozzle/jet drive wave form, even for non-jetting nozzles, it is known to compensate for retracted ink meniscus effects. However, it will be appreciated that these MAP signals are part of an actually jetting print head as to do otherwise would further complicate print head operation. It is also known to trigger MAP action at a fixed frequency between print jobs when the printer is left in an idle state as outlined above. This cycles all nozzles and jets in the printer so there is a need for the whole print head to be idle.

Aspects of the present invention run a MAP operation for any specific nozzle or head which has not fired for a configurable/predetermined length of time or some other pre-determined factor or combination of factors. It is advantageous to activate all nozzles if the whole print head has not fired for a predetermined time period. This can even be between pixels in an active print job and could consist of an arbitrary number of MAPs if time/frequency allowed.

It will be appreciated that behavior in accordance with aspects of the present invention will introduce a fixed latency or delay 24 between a trigger signal 22 received at the print head (HIB) and the actual firing of the print head. The fixed latency or lag will be arranged to be large enough to begin and complete a MAP signal sequence or event for a print head before executing the fire operation. In such circumstances, even if a print head fire/trigger is received just as a MAP event has started then the latency will anyway not attempt to fire the head until the MAP process is complete. The nature of the drive mechanism and control means that MAP signals can be specifically fired for individual nozzles or jets when it is known there will be no print demand (no jobs in a print queue).

Aspects of the present invention provide MAP signals for nozzles/jets not linked to drive signals for an actual jetting nozzle but does provide pro-active MAP signals to maintain printer operational performance by meniscus priming the nozzles.

FIG. 5 provides a schematic illustration of a meniscus activation method in accordance with aspects of the present invention. There is a meniscus activation mode 101 for a print nozzle (during which akin to MAP signals akin to 21 previously are fired) and a print mode 102 (during which fire signals akin to 22 previously are fired) with each defined in symbolic form from a waveform controller 105 with data input 103 to the printer head interface (HIB—not shown) for the nozzles and the data output to fire the nozzles or nozzles in a print head. The driving process as described above is made as a common drive signal waveform presented to the head via a waveform controller 105.

In such circumstances aspects of the present invention provide Meniscus Activation Pulses (MAP) 106a, 106b at a MAP firing frequency 107. As can be seen with MAP 106a there is no print activity. During MAP 106b there is a first print driving signal (also referred to as a driving packet or package) 108 presented at the data path input 103 comprising a fire signal 109 and print data 110 along with a second print drive signal 118 (also referred to as a drive packet or package) comprising a second nozzle fire signal 119 and a second data signal 120.

With aspects of the present invention there will always be a delay 111 (akin to latency or delay 24 previously) to accommodate the MAP process. The remainder of the print mode 102 operation is delayed by delay 111 but is in sequence so first print driving signal 108 is delayed but shifted to a first firing stripe 112 as delayed first fire signal 109s and first data signal 110s in the data path output to the print nozzle as second firing stripe 113 comprising second nozzle fire signal 119s and second data signals 121s all equally delayed by delay 111 but remain in sequence.

In accordance with aspects of the present invention the printing sequence comprises a number of signals 108, 118 for the nozzle so that all will just be delayed with sequencing between the signals 108, 118 maintained. The consistent delay 111 will typically be a matter of up to 10 milliseconds for example so that overall print accuracy will not be affected but the readiness and predictability of nozzle performance improved compared to prior arrangements. In other examples, the delay 111 is greater than or equal to 10 milliseconds.

As indicated above, each nozzle or jet will have a MAP. The print process itself as described will involve each jet/nozzle firing in a raster to form an image so the delay 111 to one fire sequence for that nozzle in the raster or a succession of nozzles will also be delayed. However, it will also be understood that print heads will generally have a return when the nozzles are inactive as the head turns as it goes back and forth, one way and then the other. Thus, the fixed delay 111 may be for one traverse or pass across the print substrate. The delay can be reset in the normally non-operative return period when the nozzle/jet in the print head is mechanically turned or otherwise so would be not fired anyway. If the pre-defined parameter such as time since last printhead nozzle firing is exceeded or met, then the fixed delay or latency is then applied after each such traverse of the printhead.

The present invention provides a proactive MAP process which is linked to a known necessity. Previously, MAP has been used as part of the current actual print jetting operation or periodically irrespective of whether it is needed or not so causes delay when not required and may be wasteful of capacity. The present invention monitors with respect to pre-defined parameters (number of pixels, ink temperature etc.) but mainly time since last operation for each nozzle and jet to identify meniscus activation factors/parameters for that nozzle or jet at least in terms of time since last operation.

Some jets/nozzles may be more in need of MAP than others and so may be prioritized, but this will add complexity so is not normal. The likelihood of a nozzle fire sequence coinciding with a MAP fire will be reduced particularly if some forward understanding of individual nozzle demand is known. Although greatly increasing complexity and possibly introducing delay, the order of MAP signals to each nozzle may be changed to match when ink ejection is required or some jets/nozzles not subject to MAP or at a lower frequency if that jet/nozzle has a high duty cycle so the need to maintain meniscus is reduced compared to sporadically used jets/nozzles. However, this will add significantly to operational complexity so generally all nozzles will be subject to MAP signals in a sequence and the delay for the common drive signal of sufficient time to ensure that all nozzles are primed by the MAP signals to each nozzle. Thus, it will not normally be necessary to reduce the number or alter the sequence of MAP signals down to only some of the nozzles in order to ensure completion of the MAP signal sequence with in the available delay or latency as this will generally be more than enough to allow completion of a MAP signal sequence to all nozzles of the print head.

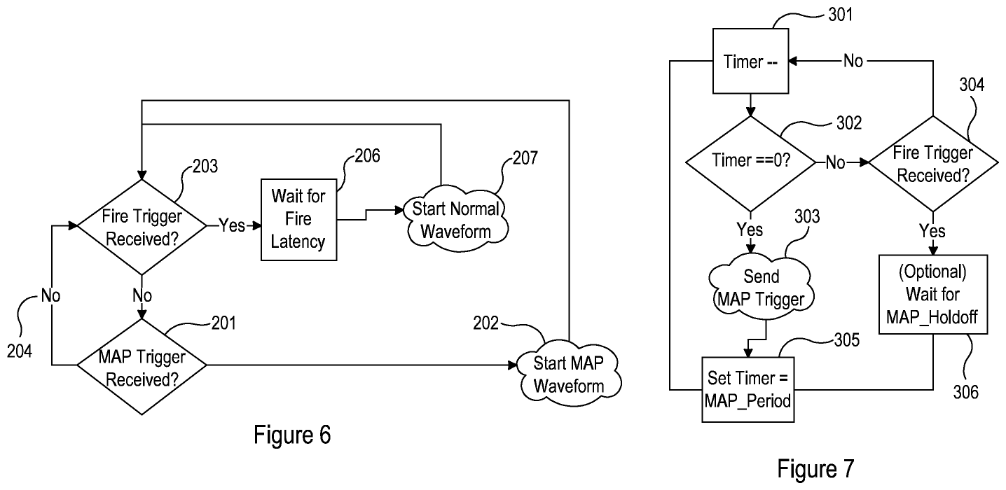

FIG. 6 provides a flow diagram of the steps involved with provision of meniscus activation pulses in a sequence according to aspects of the present invention. Thus, at a basic level if a MAP trigger is due to an activation parameter being exceeded then this is received at step 201. This trigger 201 will start a meniscus activation wave form at step 202 presented to each nozzle of the print head (or a suitable sub-group thereon).

FIG. 7 indicates a timer process which generates a MAP trigger 303 when a timer 301,301,305 completes a predetermined MAP period. If an external Fire Trigger is received 304 then the MAP period timer will begin counting again without generating a MAP Trigger. FIG. 7 indicates a control process for waveform generation. If a MAP Trigger is received from the process in FIG. 7 201 then a MAP waveform will be started 202 and monitoring for triggers 203,205,201,204 will resume. (Waveform generation being a parallel process—not shown). If an external Fire Trigger is received 203 (same signal as 304) then the FIG. 6 process as described above will wait for a predetermined latency 206 then start Normal Waveform generation 207 The process will then return to monitoring for triggers.

The delay 206 will be defined as greater than the duration of the MAP waveform so that wave form generation 207 will never take place while the MAP waveform is still being generated.

A MAP sequence is only triggered when the activation parameter is exceeded (usually a time period) and once activated the delay is always enough such that if a fire trigger is received then the MAP sequence will be competed. If the print fire trigger is some time e.g. X milliseconds after the start of the MAP sequence then there will be that time after X plus the delay so more than enough by X milliseconds while if the start of the MAP sequence and the print fire trigger are simultaneous then the delay/lag alone will be enough time to allow the MAP to be completed before the trigger is activated by the start of the common drive waveform 207.

The delay or latency is normally fixed as it depends on the design of the MAP waveform and the printhead and drive system.

FIG. 7 provides a simple illustration of the flow of steps in a timer sequence used to control the delay process as described in FIG. 6 in accordance with aspect of the present invention. Thus, a timer 301 is provided with a logic step 302 to determine whether the timer is set to 0 if yes then a MAP trigger 303 will be generated, and the timer set to the desired MAP periodicity. The control in FIG. 6 will then start generating a MAP waveform 202 in response to receiving the trigger 201.

If a print fire trigger 304 is received while the logic step 302 is set other than to 0 then after an optional MAP holdoff period, the MAP timer will be restarted at the desired MAP periodicity 305. The total of MAP Holdoff and MAP Period together must be at least as great as the duration of the total of the normal waveform and fire Latency 206 to avoid future MAP trigger conflicting with fire Trigger. The MAP period 305 must be at least as great as the duration of a MAP waveform.

It will be appreciated that during periods of printer inactivity the printer may be configured to perform different operations from MAP pulses simply strictly in accordance with aspects of the present invention. Namely, in order to save power or to extend the lifetime of the printhead or HIB, a power down (partially or completely) of some or all of the printhead or HIB (possibly including individual nozzles) is possible. In such circumstances aspects of the present invention provide a fixed delay to generated waveforms to a printhead after a fire signal which is great enough to perform such a power down, and also to power up again when necessary.

The same delaying as with aspects of the present invention to provide MAP operation could also be used to perform some kind of power-down operation if the print process were stopped for a long enough hold off period. The time delay should be sufficient that if the process had just started to execute a power down, there would still be enough time to power up again while maintaining a constant latency between fire trigger and the actual generated printhead drive waveforms in accordance with aspects of the present invention for MAP.

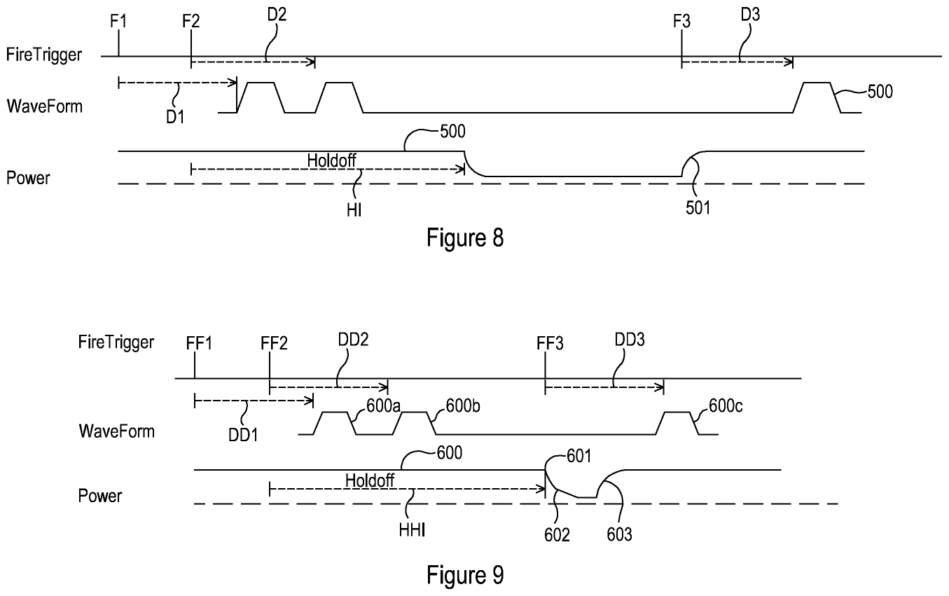

FIG. 8 and FIG. 9 provide illustrations of fire signals, generated printhead driver wave forms and power down/power up periods of a printhead for a first and a second respective scenario. In a first scenario depicted in FIG. 8 printhead fire signals F1, F2, F3 are shown as is typical with a print process so spaced as necessary for the print image. In accordance with aspects of the present invention these fire signals F1, F2, F3 are received but these are delayed by periods D1, D2, D3 so the generated driver waveforms to operate the printhead are after the fire signals F1, F2, F3. As discussed, the line 500 shows power level i.e. on or shut down for a printhead. Thus, after a period beyond the fire signal F2 the power is shut off. Clearly, without a MAP process in accordance with aspect of the present invention, this period can be set as required but in accordance with aspects of the present invention this delay period must be adequate to accommodate the delays D1, D2 so there is a holdoff period H1. In such circumstances the power can be turned off after the holdoff period H1 until another fire signal F3 is received and a power back on occurs at point 501 so that the fire signal F3 can be effective after a delay D3 to generate a suitable waveform 502 to the printhead.

FIG. 9 shows a second scenario where a fire signal FF3 is received almost immediately after a power off at a point 601 in a graphical depiction of power level as line 600 showing a power level for a printer (on or shutdown/standby). As will be seen, fire signals FF1, FF2 and FF3 are provided to drive a printer and these create waveforms 600a, 600b, 600c after delays DD1, DD2 and DD3 respectively. A holdoff period HH1 is provided so that the fire signals FF1, FF2 have time to be effective. The delay DD3 is adequate after the fire signal FF3 so that the natural power off curve (602)—power up curve (603) can be accommodated within the delay DD3 while still allowing generation and action by waveform 600c on a printhead as a result of delay DD3 after fire signal FF3.

With the provision of delays D1, DD1, D2, DD2, D3, DD3 for MAP in accordance with aspects of the present invention, it will be appreciated that it is easier to accommodate power downs for operational reasons such as to save power. The power down may be to complete shut off or to a stand-by state with no or a reduced power levels respectively. The different necessary time periods to power down/power up to operational status (illustrated as curves 602, 603 in FIG. 9) require time periods that can be accommodated within the delay for MAP in accordance with aspects of the present invention.

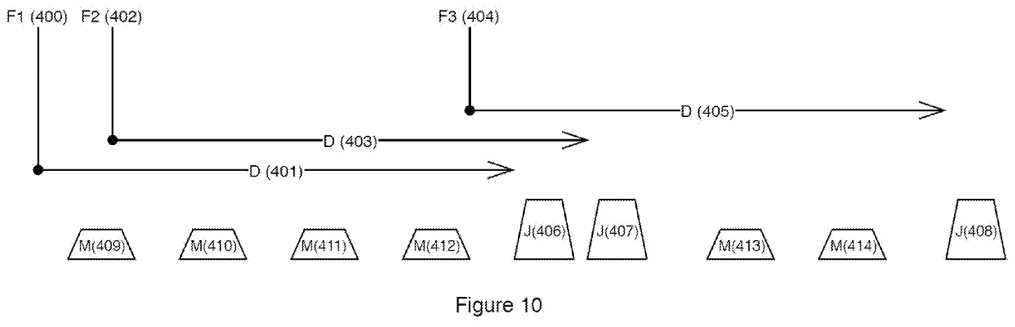

In a further aspect of the invention, Fire Request signals could be queued such that several Fire Request signals could be received, delayed, and then take effect to produce jetting events. FIG. 10 shows a scenario in which Fire Request signals F1(400), F2(402) and F3(404) are delayed respectively by D(401), D403) and D(405). Just prior to D(401) completing—which causes Jetting Waveform J(406), all 3 events are held in the queue. The time to next Jetting Waveform is indicated by the Delay Queue and is used by the MAP controller to control the generation of MAP waveform M(409) to M(414). These will be generated only when the Time to Next Jetting Waveform is greater than the duration of a MAP. This has the advantage that delays can be much larger than a system without a queue for a given Fire Frequency.

It should be understood that the queued embodiment is illustrative only. For example, MAP waveform requests could be injected into the queue, on identification of suitable gaps, rather than being generated only by responding to outputs.

Although the invention has been described in terms of preferred embodiments as set forth above, it should be understood that these embodiments are illustrative only. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein.

1. A drive system for a plurality of individually switched nozzles with drive signals common to the plurality of individually switched nozzles of an inkjet print head, the drive system comprising:
a nozzle controller associated with at least one nozzle whereby meniscus activation is determined by a meniscus activation pulse, MAP, signal to the at least one nozzle, the nozzle controller being configured whereby fire waveforms are delayable by a configurable fire latency; and
a MAP controller defining at least one parameter for the at least one nozzle and such that the at least one parameter is monitored by the MAP controller, whereby a MAP signal is provided to the nozzle controller as required, each nozzle configured whereby there is a fixed delay period at least until meniscus activation at the nozzles by the MAP signal is complete, the nozzle controller ensuring that subsequent nozzle fire signals as drive signals common to the plurality of individually switched nozzles are delayed by the fixed delay period but remain in sequence with each other.

2. The drive system of claim 1, wherein the at least one parameter is defined for each nozzle or a specific group of nozzles.

3. The drive system of claim 1, wherein the at least one parameter is a time period since last operation of that nozzle.

4. The drive system of claim 1, wherein each nozzle in the print head is linked whereby each nozzle in turn comprises a MAP signal.

5. The drive system of claim 4, wherein each nozzle comprises a MAP signal in a pre-defined order.

6. The drive system of claim 1, wherein each nozzle comprises a MAP signal dependent upon the at least one parameter for that nozzle.

7. The drive system of claim 1, wherein the fire latency is in a range up to 10 milliseconds.

8. The drive system of claim 1, wherein the fire latency is greater than, or equal to 10 milliseconds.

9. The system of claim 1, wherein the MAP signal is part of a waveform signal to drive the nozzle whereby an ink meniscus is moved.

10. The drive system of claim 1, wherein the MAP for a particular nozzle can be cancelled if the parameter has been met in a time period prior to an expected need for a MAP signal for that nozzle.

11. The system of claim 1, wherein the MAP for each, some or all of the nozzles can be suspended.

12. The drive system of claim 1, wherein a range of MAP signals are provided for each, groups or all nozzles in a look up table and a particular MAP signal chosen depends upon determination of a current at least one parameter and/or previous at least one parameters and/or expected variations in the at least one parameter.

13. The drive system of claim 1, wherein the delay period is determined such that any time for power down and power up of the printhead is less than the delay period.

14. A method of operating a plurality of individually switched nozzles of an inkjet print head with drive signals common to the plurality of individually switched nozzles, the method comprising:
determining a meniscus activation pulse, MAP, signal for meniscus activation by a MAP signal for each nozzle of a print head; and
defining at least one parameter for at least one nozzle such that the at least one parameter is monitored, whereby the MAP signal is provided to a nozzle controller as required, each nozzle configured whereby there is a fixed delay period at least until meniscus activation at the nozzles by the MAP signal is complete, the nozzle controller ensuring that subsequent nozzle fire signals as drive signals common to the plurality of individually switched nozzles are delayed by the fixed delay period but remain in sequence with each other.

15. The method of claim 14, wherein the parameter is defined for each nozzle or a specific group of nozzles.

16. A method of claim 14, wherein the parameter is a time period since last operation of that nozzle.

17. A method of claim 14, wherein each nozzle in the print head is linked whereby each nozzle in turn comprises a MAP signal.

18. A method of claim 17, wherein each nozzle comprises a MAP signal in a pre-defined order.

19. A method of claim 14, wherein each nozzle comprises a MAP signal dependent upon the parameter for that nozzle.

20. A method of claim 14, wherein the delay period is in a range up to 100 microseconds.
